(19) United States
(12) Patent Application Publication
(10) Pub. No.: US 2005/0094189 A1
(43) Pub. Date: May 5, 2005

(54) Electronic-mail receiving apparatus, electronic-mail communication system and electronic-mail creating apparatus

(76) Inventors: Motoaki Aoyama, Tokyo (JP); Masaki Kakutani, Hiratsuka-shi (JP); Shunichi Kumakura, Tokyo (JP); Seiichi Hanji, Tokyo (JP)

Correspondence Address: CANTOR COLBURN, LLP, 55 GRIFFIN ROAD SOUTH, BLOOMFIELD, CT, 06002, US

(21) Appl. No.: 10/612,506

(22) Filed: Jul. 2, 2003

(30) Foreign Application Priority Data
Jul. 9, 2002 (JP) JP2002-199655

(51) Int. Cl. G06F 3/12; G06F 13/00

(52) U.S. Cl. 358/1.15; 709/206

(57) ABSTRACT

There is described an electronic mail communication system, which conduct an image-forming operation and a finishing processing at a site of a receiver, based on the command sent from the sender. The system includes an electronic mail creating apparatus, which has an image data acquiring means, a finishing information acquiring means and a mail data generating means for generating mail data including address of the receiver, finishing information and image data, and an electronic mail receiving apparatus, which receives the mail data including the image data and the finishing information and acquires the image data and the finishing information by means of an analyzing means, and then, conduct a finish setting by comparing the finishing information with the contents of outputtable finishing operation, so as to conduct the image-forming operation and the finish processing.

### BACKGROUND OF THE INVENTION

This invention relates to an electronic-mail receiving apparatus, an electronic-mail communication system, and an electronic-mail creating apparatus, each of which enables the sender to specify a finishing content in an electronic mail that contains image data and information to finish image creation and enables the receiver to finish image creation according to the specification.

Heretofore, when creating and outputting images to paper sheets, etc. for example when outputting images from a personal computer to a printer, the user can specify a finishing method such as stapling of paper sheets on the personal computer before outputting the image data to the printer. In this case, the image data and finishing-related information are created in a data format fit for the printer and sent to the printer from the personal computer. Consequently, personal computers and servers must respectively have printer driver software fit for their printers in advance, which limits personal computers and servers to which image data is sent for printing via a network.

Facsimile apparatus contain the same technology as the above apparatus judging from that they create images from image data and output them.

When a finishing content is set in advance, the conventional facsimile technology can output images according to the finishing content based on the setting. However, even when the sender transmits data with an output specification, the receiver cannot output images if the receiver does not conform to the output specification.

Further, for confirmation of whether the image data sent by a sender with an output direction is output by a receiver correctly as it is directed, a printing system has been proposed (by Japanese Application Patent Laid-open Publication No. Hei 13-312381) which sends back information about output of the received data in the form of an electronic mail to the sender.

However, every conventional technology is based on the premise that the receiver can get a print result the sender intended and requires that the sender system and the receiver system are completely matched with each other. Accordingly, there has been a problem that the sender and the receiver are limited and applicable range of the system is also limited.

### SUMMARY OF THE INVENTION

To overcome the abovementioned drawbacks, it is an object of the present invention to provide an electronic-mail receiving apparatus, an electronic-mail communication system, and an electronic-mail creating apparatus, in which the transmitting operation of the image data at the sender, the output commanding operation at the sender and output operation at the receiver can be conducted even when the sender system and the receiver system are not necessary completely matched with each other.

Accordingly, to overcome the cited shortcomings, the abovementioned object of the present invention can be attained by electronic-mail receiving apparatus and electronic-mail communication systems described as follow.

(1) An apparatus for receiving an electronic mail, the apparatus comprising: a receiving section to receive electronic-mail data including image data and finishing information for image forming operation based on the image data; an acquiring section to acquire the image data and the finishing information from the electronic mail data; a finishing information judging section to compare the finishing information with finishing contents processible for the apparatus; a selecting section to select whether or not a changing operation of the finishing information is necessary, when the finishing information includes a finishing content unprocessible for the apparatus; and a finish setting section to conduct a finish setting operation based on a result of a selecting operation conducted by the selecting section.

(2) The apparatus of item 1, further comprising: an electronic mail analyzing section to acquire the image data and the finishing information included in the electronic mail by analyzing the electronic mail, when receiving the electronic mail.

(3) The apparatus of item 1, further comprising: an apparatus-finishing content storing section to store the finishing content processible for the apparatus.

(4) The apparatus of item 1, wherein, when the finishing information judging section determines that the finishing information do not include the finishing content unprocessible for the apparatus as a comparison result, the finishing information is applied for the finish setting operation as it is.

(5) The apparatus of item 2, wherein the electronic mail analyzing section includes a finishing information rule storing section to store a rule with respect to a description of the finishing information, and analyzes the electronic-mail data based on a content stored in the finishing information rule storing section to acquire the finishing information, when analyzing the electronic-mail data.

(6) The apparatus of item 5, wherein the finishing information rule storing section stores a tag description and the finishing information while correlating them with each other.

(7) The apparatus of item 1, further comprising: a notifying section to notify a sender of the electronic mail, when the finishing information of the electronic mail includes the finishing content unprocessible for the apparatus.

(8) The apparatus of item 7, wherein the notifying section notifies the sender of a fact that the finishing information includes the finishing content unprocessible for the apparatus and a processing content corresponding to the fact.

(9) The apparatus of item 1, further comprising: a notifying section to notify a sender of the finishing content processible for the apparatus.

(10) The apparatus of item 1, wherein finishing contents are different from each other depending on senders.

(11) The apparatus of item 1, further comprising: an individual-sender finishing content storing section to store identifying information for an individual-sender and a finishing content, which is allowed for the individual-sender, while correlating them with each other.

(12) The apparatus of item 1, further comprising: a sender rejecting section to stop an image-forming operation based on the image data included in the electronic mail, when an address of a sender coincides with a rejecting address established in advance.

(13) The apparatus of item 1, further comprising: a sender restricting section to allow an image-forming operation based on the image data included in the electronic mail, only when an address of a sender coincides with an allowed address established in advance.

(14) The apparatus of item 1, further comprising: an image-forming section to conduct an image-forming operation based on the image data.

(15) The apparatus of item 1, further comprising: a finishing section to apply a finish processing to a formed image; wherein the finishing section performs the finish processing based on the finish setting.

(16) An apparatus for receiving an electronic mail, the apparatus comprising: a receiving section to receive electronic-mail data including image data and finishing information for image forming operation based on the image data; an acquiring section to acquire the image data and the finishing information from the electronic mail data; a finishing information judging section to compare the finishing information with a finishing content processible for the apparatus; and a process selecting section to select whether a processing operation should be proceeded or stopped, when the finishing information includes a finishing content unprocessible for the apparatus as a comparison result conducted in the finishing information judging section.

(17) An apparatus for receiving an electronic mail, the apparatus comprising: a receiving section to receive electronic-mail data including image data and finishing information for image forming operation based on the image data; an acquiring section to acquire the image data and the finishing information from the electronic mail data; a finishing information judging section to compare the finishing information with a finishing content processible for the apparatus; and a process stopping section to stop a finish processing, when the finishing information includes a finishing content unprocessible for the apparatus as a comparison result conducted in the finishing information judging section.

(18) An apparatus for receiving an electronic mail, the apparatus comprising: a receiving section to receive electronic-mail data including image data and finishing information for image forming operation based on the image data; an acquiring section to acquire the image data and the finishing information from the electronic mail data; a finishing information judging section to compare the finishing information with a finishing content processible for the apparatus; and a finish setting section to conduct a finish setting operation, which does not include a finishing content unprocessible for the apparatus, after changing the finishing information in respect to the finishing content unprocessible for the apparatus, when the finishing information includes the finishing content unprocessible for the apparatus as a comparison result conducted in the finishing information judging section.

(19) A system for communicating an electronic mail, the system comprising: an electronic mail creating apparatus to create electronic-mail data including image data and finishing information; and an electronic mail receiving apparatus that includes a receiving section to receive the electronic-mail data including the image data and the finishing information transmitted by the electronic mail creating apparatus, and a finishing information judging section to compare the finishing information with a finishing content processible for the apparatus, to conduct an image-forming operation based on the finishing information; wherein the electronic mail receiving apparatus notify the electronic mail creating apparatus, when the finishing information includes the finishing content unprocessible for the apparatus as a comparison result conducted in the finishing information judging section.

(20) A system for communicating an electronic mail, the system comprising: an electronic mail creating apparatus to create electronic-mail data including image data and finishing information; and an electronic mail receiving apparatus that includes a receiving section to receive the electronic-mail data including the image data and the finishing information transmitted by the electronic mail creating apparatus, to conduct an image-forming operation based on the finishing information; wherein the electronic mail receiving apparatus notify the electronic mail creating apparatus of finishing information processible for the electronic mail receiving apparatus, corresponding to an inquiry from the electronic mail creating apparatus to the electronic mail receiving apparatus.

(21) A system for communicating an electronic mail, the system comprising: an electronic mail creating apparatus that acquires image data and an address of a receiver when creating the electronic-mail, to create electronic-mail data including the image data, the address of the receiver and finishing information for forming an image based on the image data; and an electronic mail receiving apparatus described in item 1.

(22) An apparatus for communicating an electronic mail, the apparatus comprising: an acquiring section to acquire the image data and an address of a receiver of the electronic mail; and an electronic mail creating section to create electronic-mail data including finishing information described by the image data, the address of the receiver of the electronic mail and a tag.

(23) The apparatus of item 22, wherein the finishing information includes at least one of a designation of color or black and white, a designation of enlargement or reduction and a punching operation.

(24) The apparatus of item 22, wherein the finishing information are described in a main description of the electronic mail.

(25) The apparatus of item 22, wherein the finishing information are described in a header of the electronic mail.

(26) The apparatus of item 23, further comprising: an image data acquiring section to acquire the image data; a receiver acquiring section to acquire the address of the receiver of the electronic mail; a finishing information acquiring section to acquire the finishing information for forming an image; and an electronic-mail data generating section to generate the electronic-mail data including the address of the receiver, the finishing information and the image data.

(27) The apparatus of item 26, wherein the electronic-mail data generating section is so constituted that it generates the electronic-mail data, which has the address at a header, the finishing information provided as a main description and the image data added to the main description.

(28) The apparatus of item 26, wherein the image data acquiring section is provided with an image data storing section in which the image data are stored.

(29) The apparatus of item 26, wherein the image data acquiring section is provided with a scanner for reading an image to generate the image data.

(30) The apparatus of item 26, wherein the receiver acquiring section is provided with a receiver inputting section for setting a receiver by means of an inputting operation of a sending operator.

(31) The apparatus of item 26, wherein the receiver acquiring section is provided with a receiver storing section for memorizing a receiver.

(32) The apparatus of item 26, wherein the finishing information acquiring section is provided with a finishing information inputting section for setting the finishing information by means of an inputting operation of a sending operator.

(33) The apparatus of item 26, wherein the finishing information acquiring section can acquire only such finishing information that are described by a rule established in advance.

(34) The apparatus of item 33, wherein the rule relates to a description by a tag.

(35) The apparatus of item 26, wherein the finishing information acquiring section is provided with a finishing content storing section for storing finishing content data being acquirable.

(36) The apparatus of item 26, further comprising: a model finishing content storing section to store a finishing content being processible as data of every model for a finishing section.

(37) The apparatus of item 26, further comprising: a receiver model data storing section that stores model data of a finishing section provided in the receiver while correlating it to receiver identifying information.

(38) The apparatus of item 26, wherein the apparatus is so constituted that the apparatus acquires receiver identifying information to identify a receiver, and can select a finishing content being usable for a finishing section provided in the receiver.

(39) The apparatus of item 26, wherein the apparatus is so constituted that the apparatus acquires receiver identifying information, and acquires receiver model data from the receiver model data storing section, based on the receiver identifying information, and acquires a finishing content being selectable from model finishing content storing section, based on the model data.

(40) The apparatus of item 26, further comprising:
an inquiring section to inquire a finishing content being processible for a receiver from the receiver.

(41) The apparatus of item 40, wherein, when the inquiring section obtains the finishing content being processible for the receiver, the finishing information acquiring section can acquire only such finishing information that are limited within the finishing content.

(42) The apparatus of item 26, further comprising: a communicating section to communicate the electronic mail by coupling to a network.

The electronic-mail receiving apparatus, the electronic-mail communication system, and the electronic-mail creating apparatus of this invention enable the sender to specify finishing information in an electronic mail so that the receiver may output images as the sender intended. Therefore, even when the sender and the receiver are not matched completely as systems, the receiver can output images according to the finishing content that the sender intended.

In other words, the electronic-mail receiving apparatus, the electronic-mail communication system, and the electronic-mail creating apparatus of this invention are effective particularly when the receiver (a receiving apparatus) does not have a function to output images according to the finishing information that the sender intended.

It is possible to disable input (selection) of finishing information such as an unsupported tag (function) by checking whether the receiver supports the preset finishing information before the sender sends data.

The above electronic mail can be made up with a header, image data, and information to finish an image acquired from the image data. This simple data structure can direct a finishing content for the receiver. Further, the electronic-mail data enables configuration of image data and finishing-related data by rules independent of receiver models. Furthermore, the electronic mail can have a definition of a preview tag to send a simple model of a printed image to the receiver. By this preview function, the receiver can check the content of the mail and discard unwanted data before printing. This can save printing expendables (toner, ink, paper, etc.).

A receiving apparatus for receiving electronic mails via a network receives electronic-mail data containing at least image data and information to finish images according to the image data and acquires the image data and the finishing information from the image data. The finishing information is not always limited to those the receiver, can output.

Therefore, the transmitted finishing information can contain any other than the finishing content the apparatus can process. This invention prevents occurrence of errors on the receiver side by checking whether the finishing information contains any other than the finishing content the apparatus can process by comparison.

The electronic-mail receiving apparatus in accordance with this invention enables the user to change finishing information by the result of comparison.

Further, the receiving apparatus enables the user to select either advancing or stopping later processing by the result of comparison or to stop later processing by the result of comparison. If the finishing information contains a finishing content that the receiving apparatus cannot process as the result of comparison, the apparatus enables the user to change the finishing information to exclude such a finishing content that the apparatus cannot process.

The other items, acquisition of image data, and acquisition of finishing information, etc. of the electronic-mail receiving apparatus are similar to those of the electronic-mail creating apparatus to be explained later.

Further, the electronic-mail receiving apparatus of this invention compares the finishing information in the acquired electronic-mail by the processible finishing content of the apparatus and makes a finishing setting according to the result of comparison. The processible finishing content of the apparatus is kept as data in the apparatus finishing content storing means of the receiving apparatus made up with an appropriate storing medium such as a HDD and called for comparison if necessary.

The above setting of finishing information by the result of comparison can be made by the receiver operator according to the displayed result of comparison or can be made automatically by a preset procedure according to the result of comparison. For example, when the received finishing information is contained in the processible finishing content of the receiver, the receiver can finish images according to the finishing information. In other words, when the data receiving party (which is going to print data) is equipped with all functions and abilities that the data sending party requires and has a default setting that does not limit the specified functions and abilities, complicated output settings can be enabled without any particular operations and settings.

Contrarily, when the received finishing information contains a finishing content that the receiver cannot process, the user can select either to change or not to change the finishing information (including partial deletion). When the finishing information is changed (including partial deletion), the user can make a finishing setting according to the changed finishing information. The processing can be implemented by a finishing information judging means or the like which comprises a CPU and a program. Therefore, when a new tag (function) definition or the like is added as finishing information and only the sender has this function, the receiver may merely disuse this new tag (function) and will never stop the system. This addition of a new tag (function) makes the systems compatible as the systems can operate normally even when only the data sender has a new tag (function).

Additionally, the electronic-mail receiving apparatus of this invention can stop the processing temporarily or definitely when the received finishing information contains finishing information that the apparatus cannot process as the result of comparison. Further in this case, the user can also select either to advance or to stop processing of image data.

The electronic-mail receiving apparatus can be equipped with an electronic-mail analyzing means that analyzes electronic-mail data and acquires the above data and finishing information. This analyzing means can further contain a finishing information protocol storing means that stores finishing information defined by a preset protocol and uses the stored information to analyze the electronic-mail data. The finishing information protocol storing means can use an appropriate storage medium such as HDD. An example is illustrated as a finishing information protocol storing means in which tag description is related to finishing information.

If the received finishing information contains a content that the electronic-mail receiving apparatus cannot process as the result of comparison, the electronic-mail receiving apparatus can notify the sender of it. In this case, this notifying means can notify the above status only. It can also notify that the received finishing information contains a finishing content the receiving apparatus cannot process together with a processing content corresponding to the above status. The processing content can contain change of finishing information, stop of processing, cancellation of processing, and so on.

The electronic-mail receiving apparatus of this invention acquires image data from electronic-mail data and then processes to create images from the data. This image creation can be performed by an appropriate image creating apparatus and it is not to be construed to limit the scope of this invention. Usually, this apparatus creates images on paper sheets from image data, that is, this apparatus creates images using print data that is converted to be fit into a preset form size from the image data. This invention does not limit the method of creating images. Most image creating methods comprise the steps of preparing a photosensitive member, forming a latent image on the photosensitive member, and transferring the image from the photosensitive member to a paper sheet. The image creating apparatus can be prepared in an apparatus dedicated for reception of mails or prepared as an apparatus that may be used for the other purpose such as a copying machine or a printer for personal computer.

Further, the image creating apparatus is equipped with a finishing means that finishes the created images. The finishing means can be prepared as a finisher that performs stapling, punching, and cutting, a device that is built in the image creating apparatus and performs finishing related to data processing such as N-in-1 in the above data conversion, or both. This finishing means can perform a preset finishing process according to a finishing setting made by the electronic-mail receiving apparatus.

It is possible to acquire a finishing direction onto the finishing means from each electronic-mail and use it directly. It is also possible to cause the receiving apparatus to create finishing control data for the finishing means from the finishing setting and apply it to the finishing means. In this case, it is possible to provide a finishing control data storing means that stores finishing control data for the finishing setting and acquire finishing control data from the storing means according to the finishing setting.

The electronic-mail receiving apparatus can be equipped with a notifying means that notifies the sender of the finishing content that the apparatus can process. The notifying means can use appropriate means such as electronic mails to notify.

Further, the electronic-mail receiving apparatus can be made to have sender-specific processible finishing contents. For example, if a color output is specified for the finishing information that contains a preset agreement of monochromatic printing only, the electronic-mail receiving apparatus can process to invalidate this output specification. For this purpose, the electronic-mail receiving apparatus can provide a sender-specific finishing content storing means that relates sender identification information to sender-specific finishing content, call a finishing content from the storing means by the sender identification information (sender's address), and finish the output according to the called finishing content.

Furthermore, the electronic-mail receiving apparatus can advance or stop processing depending upon senders, that is, by sender's addresses set as information in electronic mails. For example, the electronic-mail receiving apparatus can have some rejectable addresses set in advance. When receiving an electronic mail containing such a rejectable address, the electronic-mail receiving apparatus stop processing, cancel processing, or leave the operator to select advancing or canceling later processing. Similarly, the electronic-mail receiving apparatus can have some allowed addresses set in advance. When receiving an electronic mail containing such an allowed address, the electronic-mail receiving apparatus stop processing, cancel processing, or leave the operator to select advance or cancel later processing. These processes can exclude unsolicited mails and wrong addressed mails.

Image data and a receiver address are always required to create an electronic mail of this invention. The image data can be acquired from the image data acquiring means provided in the electronic-mail creating apparatus of this invention. Any image data acquiring means can be used as long as it can offer image data to be contained in an electronic mail and its acquiring method is not limited. For example, it can be such a means to acquire image data from the other apparatus via a network or connecting cables or from an appropriate storing medium such as FD, CD, DVD, and MO. It can also be an apparatus like a scanner that scans an appropriate image, creates and offers image data. The above apparatus such as an FD driving apparatus and a scanner can be built in the apparatus of this invention or provided as an external means to be connected to the apparatus of this invention.

The image data acquiring means can be equipped with an image data storing means that stores image data. The image data storing means can be HDD, MO, or the like and further a medium that can store data repeatedly is desirable as the image data storing means.

Further, this invention requires acquiring a sender's address when creating a mail. The address can be obtained for example from a receiver input means in the mail creating apparatus. The receiver input means comprises an appropriate means such as a keyboard, touch panel, and a stylus pen and can be any means as long as the sender can enter addresses thereby. Further, it can be such a means that is equipped with a receiver storing means and acquire a receiver address from the receiver storing means. Furthermore, it is possible to acquire a receiver address from an electronic mail by which the receiver requests to transmit instead of using such an input means or acquire a receiver address by analyzing receiver-related information (e.g. bar code) in the image data. Basically, the receiver input means can be such a means that can acquire receiver addresses finally.

In accordance with this invention, finishing information for the receiver must be acquired to create a mail. The finishing information can be acquired by the finishing information input means in the apparatus of this invention. Similarly to the above receiver input means, the input means can comprise an appropriate means such as a keyboard, a touch panel, and a stylus pen and enables the sender to enter and set finishing information. This finishing information input means can be used also as the receiver input means.

Further, the finishing information input means can be such a means that is equipped with a finishing content storing means that stores processible finishing contents and acquires finishing information from the whole or part of the finishing content in the finishing content storing means. Furthermore, it is possible to receive a mail containing a processible finishing content from a receiver and acquire finishing information from the finishing content in the mail instead of the above input operation. In this case, it is possible that the sender has an inquiry means, inquires the receiver, and receives a mail that contains the above finishing content from the receiver as the result of the inquiry.

The finishing information is a finishing content to be directed for a receiver and is not limited to particular contents as long as it can be processed. For example, the finishing content can contain “Stapled output,” “Output in booklet,” “N-in-one” (function for printing images of N pages on a single sheet), “Double-sided printing,” “Punching” (function for punching printed sheets), “Zoom-in & Zoom-out” (function for enlarging and shrinking images relative to the original image),” “Output form,” “Printing quality,” “Stamping,” “Color or Monochromatic” (function of printing images in color or in black and white) etc. The user can select finishing items that can be processed by receivers.

Among these items, particularly, “Zoom-in & Zoom-out” is effective in selection of a form size or in various kinds of edition. “Punching” is effective in post-processing such as distribution and the like. “Color or Monochromatic” enables selection of either printing in color faithful to the original image or in printing in black and white to save expendables and to speed up printing. This preferably increases the user's degree of freedom.

With the “Zoom-in & Zoom-out” function, the user can get enlarged images without increasing transmission data even when the receiver limits the quantity of data to be received. (Particularly, this function is effective when graphic images and the like are received.)

Similarly, the “Color or Monochromatic” function enables partial coloring of images. This can go without increasing transmission data. (Particularly, this function is effective when graphic images or the like are received.)

In addition to the above, a tag enables specification of finishing of each page as shown by a tag example in Table 1. The sender can send electronic mails to remote parties flexibly, in detail, and appropriately to print out images throughout external networks independently of firewalls and limitations of servers.

The above finishing information must be such as to be analyzed and output by the receiver. It is usually described by a common protocol that is shared by both the sender and the receiver. For example, the finishing information can be described by a tag according to a preset protocol. The finishing information acquiring means should be preferably so constructed as to check whether the entered finishing information complies with the protocol and acquire only finishing information that complies with the protocol. This can prevent occurrence of an event that the receiver cannot analyze or output.

Further, the tag description of this invention is not limited to a particular method. Any tag description is acceptable as long as finishing information can be described according to a preset protocol.

TABLE 1

| Tag example | Description (function) |
|---|---|
| (A4, A3) | Enlarge an A4 image to an A3 image |
| | and print. |
| (Punch) | Punch the printed sheets. |
| (Punch, 1-10) | Punch page 1 to page 10. |
| (Color) | Print in color. |
| (Color, 5) | Print only page 5 in color. |
| (Booklet) | Make a booklet of printed sheets. |
| (8-in-1) | Print 8 pages on one sheet. |
| “Stamp?Confidential” | Stamp “Confidential” if possible. |
| (Pass, ****, User) | Protect by password. |
| (A4, A3, B4, Stamp) | Functions available to the receiving |
| | apparatus (A4/A3/B4 printing and |
| | stamping) |
| (1-5(3), 6-8(3), | Make 3 copies of pages 1 to 5, |
| 9-12(3)) | 3 copies of pages 6 to 8, and 3 |
| | copies of pages 9 to 12. |
| (1/2) | One of two parts of a single page |
| | (wherein the page is divided into |
| | two for transmission) |

The information tag can be described in binary (e.g. data “OXFF”) instead of ASCII code (e.g. character “A”). The information tag can also be described in an attached file, not in a text body. When the tag is used together with an encryption technology, the receiver can presume (or decide) the reliability of the result of printing if it is assumed that the result may be different from a preset print result registered in the receiver.

In some cases, even when the finishing information conforms to the above protocol, the receivers may have different finishing means and have different processible finishing contents. Therefore, the finishing information acquiring means can be equipped with a model-specific finishing content storing means that stores finishing data that each model can process. Such storing means can be appropriate storage means such as HDDs and the like. In reference to data of model-specific finishing content, the user can know the finishing content that the specific finishing means can process. Further, a receiver model data storing means can be provided to know the models that the receiver has. This storing means can also be an appropriate storing means such as HDD. The user can know the finishing content that the receiver can process from data that is acquired from the receiver model data storing means and from the model-specific finishing content storing means.

The mail creating apparatus of this invention creates mail data from a receiver address, image data, and finishing information that are acquired in the above description. This creation is made by the mail data creating means. This mail data creating means can comprises a CPU and software and create mail data from the above acquired information or the like.

The mail creating apparatus of this invention is connected to a network via a transmission means. The transmission means can be such a means that comprises an appropriate modem, transmission interface, and so on and transfers data between the electronic-mail creating apparatus and a network such as Internet by an appropriate transmission protocol.

Further, the above network preferably means Internet, but it can be any of public telephone network, leased line network, LAN, and an interconnection of these networks.

Although the above system can transmit electronic mails from a sender directly to a receiver via a network, the system can be equipped with an intermediate means through which electronic mails are transferred. This intermediate means is connected to a network and performs an intermediate function by transferring received electronic mails to receivers. In the above intermediation, electronic mails can be temporarily stored in an appropriate storing means, read from there, and transferred to receivers. Further, by storing abilities of senders and receivers in an external device, apparatus, or mechanism (e.g. a database) and sharing its content, the system can transfer data at high compatibility even when the sender and the receiver have never communicated before with each other.

### BRIEF DESCRIPTION OF THE DRAWINGS

Other objects and advantages of the present invention will become apparent upon reading the following detailed description and upon reference to the drawings in which:

FIG. 1 is a schematic diagram of a mail communication system which is an embodiment of this invention;

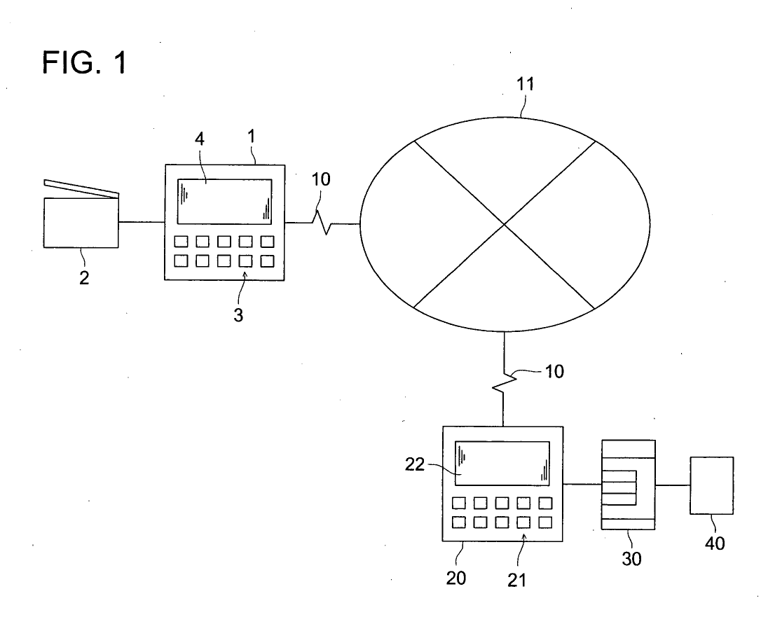

FIG. 2 shows block diagrams of an electronic-mail creating apparatus and an electronic-mail receiving apparatus which are embodiments of this invention;

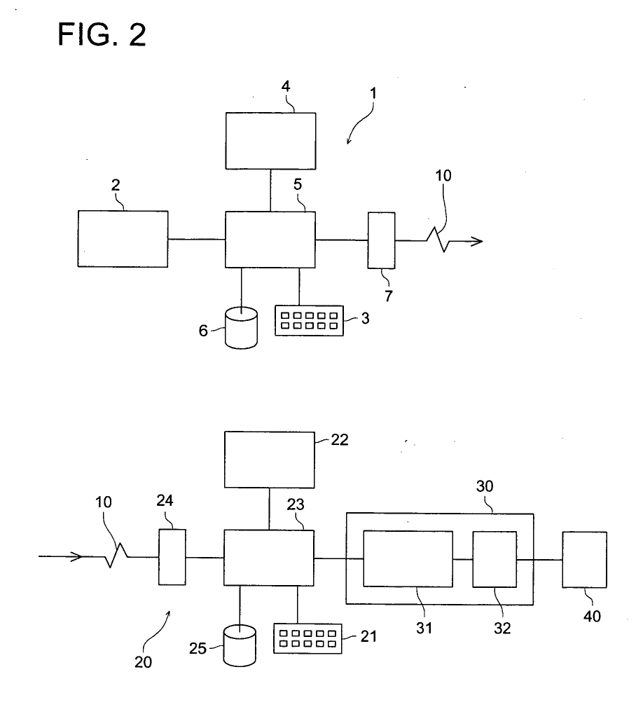

FIG. 3 shows a processing flow chart of a sender and a receiver;

FIG. 4 shows a detailed processing flow chart of Step S4;

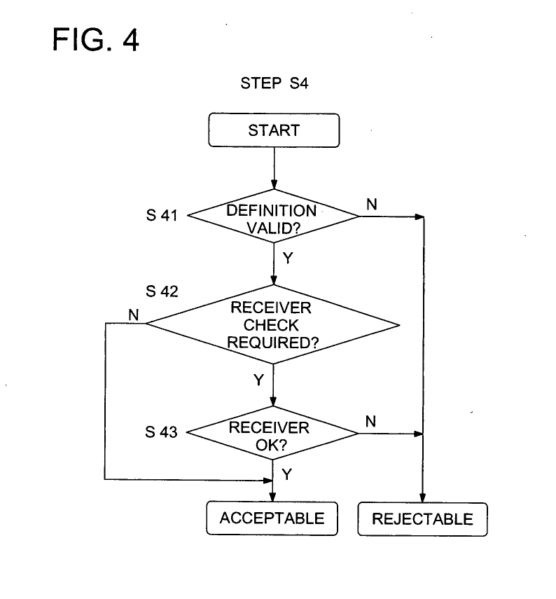

FIG. 5 shows a detailed processing flow chart of Step R4;

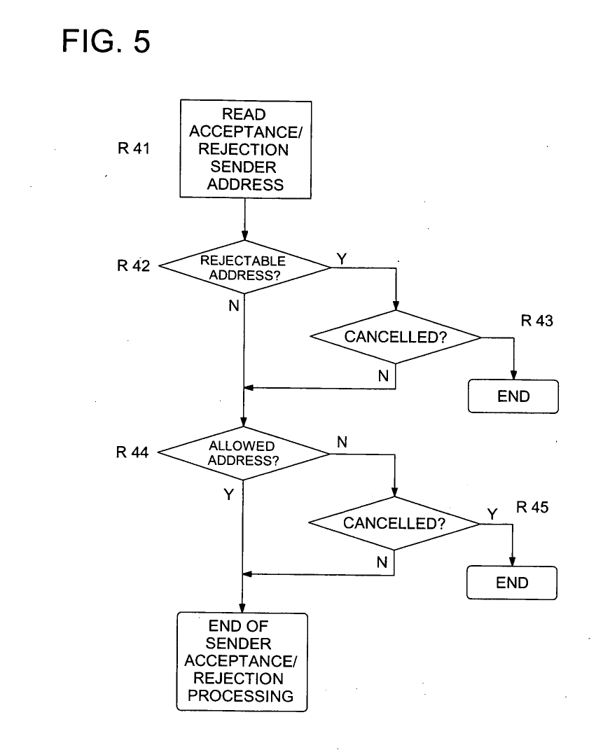

FIG. 6 shows a detailed processing flow chart of Step R5;

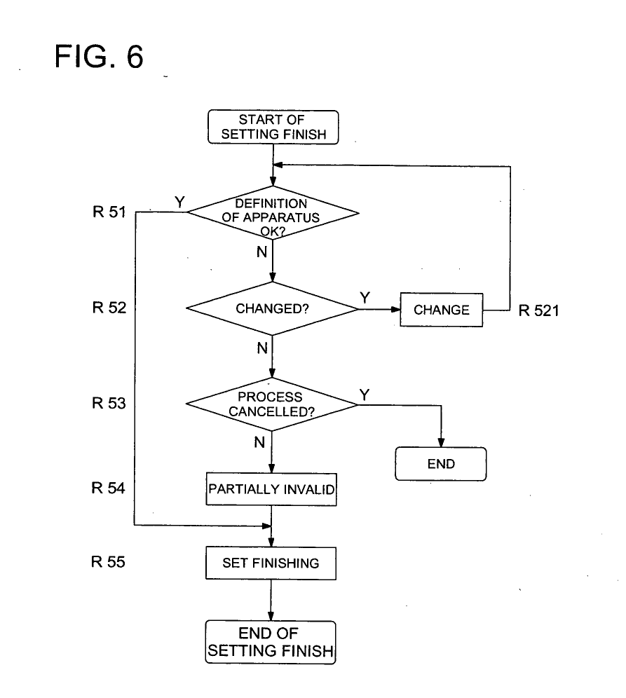

FIG. 7 shows a processing flow chart of a sender and a receiver in another embodiment of this invention; and

FIG. 8 shows a processing flow chart of a sender and a receiver in still another embodiment of this invention.

### DETAILED DESCRIPTION OF THE PREFERRED EMBODIMENT

One embodiment of this invention will be explained below in connection with the accompanying drawing.

The electronic-mail creating apparatus 1 is equipped with a scanner 2 which is an image data acquiring means to create image data. The electronic-mail creating apparatus 1 is also equipped with a keyboard 3 which works as a receiver input means and a finishing information input means and a display 4 which displays contents of operation and others. The electronic-mail creating apparatus 1 is connected through a telephone network 10 to a network 11 to which an electronic-mail receiving apparatus 20 is connected through a telephone network 10. The electronic-mail receiving apparatus 20 is equipped with an image creating apparatus 30 and a finisher 40 which is a finishing means. Similarly to the electronic-mail creating apparatus 1, the electronic-mail receiving apparatus 20 is equipped with a keyboard 21 and a display 22. The mail communication system comprises the electronic-mail creating apparatus 1 and the electronic-mail receiving apparatus 20.

This configuration will be explained in detail below. The electronic-mail creating apparatus 1 is equipped with a creating apparatus controlling section 5 that controls respective parts of, the apparatus 1. The scanner 2, the keyboard 3, and the display 4 are connected to the creating apparatus controlling section 5. Further, the mail creating apparatus 1 is equipped with an HDD 6 as a storing medium and a modem 7 through which the creating apparatus controlling section 5 is connected to the telephone network 10. The creating apparatus controlling section 5 controls this modem 7 by a specific transmission protocol for transmission to and from the network 11.

The electronic-mail receiving apparatus 20 is equipped with a receiving apparatus controlling section 23 which controls respective parts of the receiving apparatus 20. The keyboard 21, the display 22, and the image creating apparatus 30 are connected to the receiving apparatus controlling section 23. The receiving apparatus controlling section 23 can be made up with a CPU and software that are not shown in the figure. The receiving apparatus controlling section 23 is connected to a modem 24 which is connected to the telephone network 10. The receiving apparatus controlling section 23 controls the modem 24 by a specific transmission protocol for transmission to and from the network 11. Further, the receiving apparatus controlling section 23 is equipped with an HDD 25 as a storing medium. The image creating apparatus 30 comprises an image creating section 31 and an image output section 32.

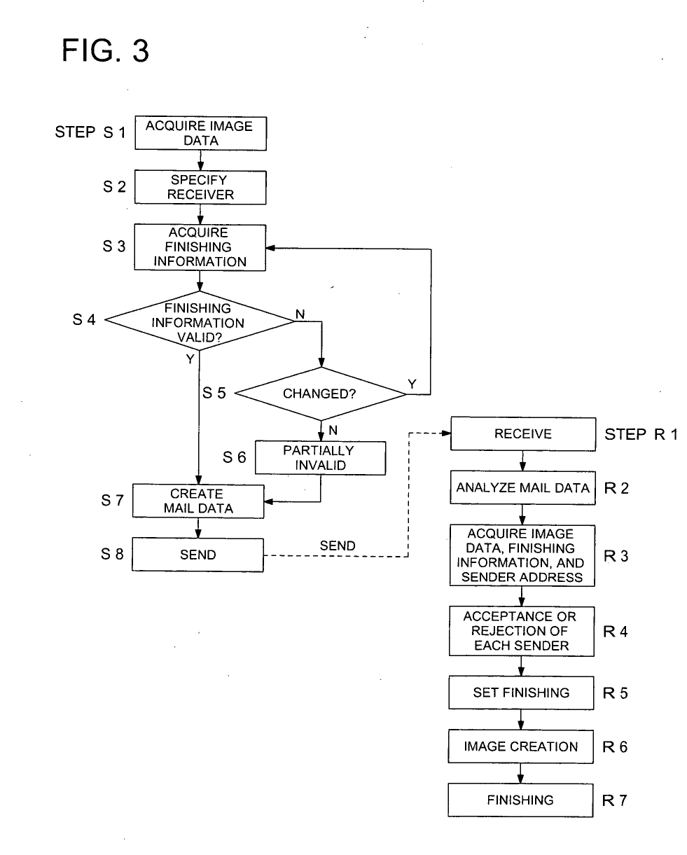

The processing procedure of the above apparatus will be explained below in connection with the flowchart of FIG. 3.

(Sender Side)

1. Acquire image data. (Step S1)

An original having image data to be sent is placed on the scanner 2 and scanned into image data. The image data is sent from the scanner 2 to the creating apparatus controlling section 5, processed there, and temporarily stored in the HDD 6. Here, the HDD6 works as an image data storing means. The creating apparatus controlling section 5 works as an electronic-mail creating means to prompt the operator to enter a receiver address and finishing information. Therefore, the creating apparatus controlling section 5 also works partially as the receiver address acquiring means and the finishing information acquiring means.

2. Specify receiver. (Acquiring a receiver address; Step S2)

This step specifies a receiver's address.

The operator enters a receiver address from the keyboard 3 and the creating apparatus controlling section 5 acquires the receiver address from the entered data. To acquire a sender address, it is possible to store some available sender addresses in the HDD 6 beforehand and select a target sender address from those stored in the HDD 6. In this case, the HDD 6 also works as a receiver address storing means.

At this step, it is also possible to make receiver models selective. When the receiver has several models, the models can have their own sub-addresses or addresses for selection.

3. Acquire finishing information. (Step S3)

This step acquires finishing information to be directed to the receiver.

The operator can acquire finishing information by operating the input means. In this case, the creating apparatus controlling section 5 acquires finishing information from the input data. It is also possible to acquire finishing information from a preset finishing content data. The finishing content data is stored in advance in the HDD 6, read out, and selected to acquire finishing information. In this case, the HDD 6 also works as a finishing content storing means. When the receiver has two or more models, it is also possible to describe finishing content (to be explained later) that a receiver model can process according to the ability of the receiver model if finishing contents that the receiver models can process are stored in advance. It is also possible to store finishing content that each model can process and receiver model data in the HDD 6 in advance. In this case, the HDD 6 also works as a model-specific finishing content storing means and a receiver model data storing means.

The above finishing information is described by a preset protocol. This embodiment uses, as a finishing content, tag descriptions of “N-in-one,” “Output in color,” “Double-sided printing,” “Zoom-in & Zoom-out,” and “Punching” to specify thereof.

4. Judgement of valid finishing information (Step S4)

This step checks whether the content of acquired finishing information is valid.

The creating apparatus controlling section 5 reads a processible finishing content from the finishing content data that is defined and stored in the HDD 6 and checks whether the above finishing information is in the processible finishing content (Step S41). If the finishing information is not in the processible finishing content (Rejectable), the creating apparatus controlling section 5 prompts the operator to enter the finishing data again or delete the finishing data (Step S5). If the finishing data is not re-entered or deleted, the finishing data can be made partially invalid (Step S6).

At Step S4, when the HDD 6 works as both a model-specific finishing content storing means and a receiver model data storing means, the creating apparatus controlling section 5 can recognize the processible finishing content by a receiver address and a receiver model and check whether the above required finishing information conforms to the finishing content (Step S43). Before this judgment, the creating apparatus controlling section 5 selects whether the judgment is implemented (Step S42). When it is judged that the finishing information contains a content that the receiver model cannot process (“Rejectable”), for example when “Stapling” is specified for a receiver model that does not have a stapling function, the creating apparatus controlling section 5 prompts the operator to enter the finishing data again or delete the finishing data (Step S5). If the finishing data is not re-entered or deleted, the finishing data can be partially made invalid (Step S6). This can reduce the receiver's operation to set finishing information as much as possible and assure the output by the receiver.

5. Create electronic mail data. (Step S7)

The creating apparatus controlling section 5 creates electronic-mail data from the receiver address, image data, and finishing information that are acquired above. In other words, the creating apparatus controlling section 5 also works as a mail data creating means.

The above electronic mail data-comprises a header and a mail part. The mail part has a data structure comprising a text body and an attached file. In this data structure, the receiver address is described in the header and the finishing information is described in the text body. Image data is attached as an attached file. Information such as a sender address and the like is also added to the electronic mail.

6. Send electronic-mail. (Step S8)

The creating apparatus controlling section 5 controls the modem 7 to send the above acquired electronic-mail data to the receiver via the network 11 by a preset protocol.

(Receiver Side)

1. Receive (Step R1)

The mail receiving apparatus 20 controls the modem 24 by the operation of the receiving apparatus controlling section 23 to receive electronic-mail data from the electronic-mail creating apparatus through the network 11.

2. Analyze electronic-mail data and acquire finishing information. (Steps R2 and R3)

The receiving apparatus controlling section 20 extracts and acquires image data and finishing information from mail data according to the above-described mail data structure. The finishing information is described by tags. The receiving apparatus controlling section 20 extracts finishing information from the tag description in the text body of the electronic-mail data according to the information which relates finishing information to the tag description stored in the HDD 25. One example of acquired finishing information is shown below.

TABLE 2

| | |
|---|---|
| N-in-1 | N-in-1 image processing |
| Color | Color image processing |
| Double-sided | Double-sided unit |
| Punch | Finisher |

3. Acceptance or rejection of each sender (Step R4)

This step determines receiver-dependent acceptance or rejection of an electronic mail.

The HDD 25 stores rejectable addresses and allowed addresses in advance, but this is optional. Rejectable addresses, allowed addresses, or none of them can be stored in the HDD 25.

This step R4 comprises the steps of reading the above address from the HDD 25 (Step R41), checking whether the above acquired sender address is one of the preset rejectable addresses (Step R42), selecting outputting or canceling the electronic mail by the operator when the sender address is a rejectable address (Step R43), ending processing when “Canceling” is selected, checking whether the sender address is one of the preset allowed addresses when the sender address is not a rejectable address or when the sender address is a rejectable address but the operator does not cancel the electronic mail (Step R44) wherein, if allowed addresses are not registered in advance, all addresses except the rejectable addresses are assumed to be allowed addresses, selecting “Canceling” when the sender address is not an allowed address at Step R44 (Step R45), and ending this acceptance/rejection processing and going to the next step (R5) when the sender address is an allowed address.

4. Set finishing. (Step R5)

(1) Definition of apparatus OK? (Checking whether the finishing information is valid to the receiving apparatus) (Step R51)

This step checks whether the receiving apparatus is equivalent to the finishing information judging means of this invention and the content of the above acquired finishing information is available to the receiving apparatus, that is, whether the acquired finishing information contains items that the receiving apparatus cannot output. It is also possible to check whether the definition of the information is valid.

In other words, the receiving apparatus controlling section 23 reads a finishing content from the finishing content data stored in the above HDD 25. This kind of data is related to information on the definition of a finishing content and also contains information about whether the finishing content can be processed by the receiving apparatus. The receiving apparatus controlling section 23 compares the above acquired finishing information by the read finishing content for evaluation. In this embodiment, the receiving apparatus controlling section 23 works as a finishing information judging means.

When it is found that the finishing information is correctly defined and can be processed by the receiving apparatus as the result of the above judgment, the receiving apparatus controlling section 23 sets finishing according to the finishing information (Step R55). When it is found by the finishing information judging means that the finishing information contains items that the receiving apparatus cannot output, the finishing information can be changed. In this case, the operator can select advancing or stopping the processing, or stop the processing. When it is found by the finishing information judging means that the finishing information contains a finishing content that the receiving apparatus cannot process, the finishing information judging means enables change of finishing information in the unprocessible finishing content and setting of finishing information without any finishing content that the receiving apparatus cannot process.

This embodiment can be so constructed as to temporarily stop processing but not to perform immediate finish-processing when the finishing information contains items that the receiving apparatus cannot output but cannot be changed. In other words, the receiving apparatus controlling section 23 can be used as a process stopping means of this invention to stop finish-processing.

Next, the receiving apparatus controlling section 23 prompts the operator to re-enter the finishing information and change (or partially delete) the finishing information. (Step R52) The step R52 is equivalent to a selection means for selecting whether finishing information of this invention is changed. This configuration enables the operator to select to change or not to change the finishing information. For example, when the operator changes the finishing information (Step R521), the receiving apparatus controlling section 23 returns to Step R51 to judge the validity of the changed finishing information.

When the finishing information is invalid and left unchanged, the receiving apparatus controlling section 23 asks the operator to select cancellation of processing or not. (Step R53) This step R53 is equivalent to the process selecting means that selects advancing or stopping the processing. This configuration enables the operator to select advancing or stopping the processing. For example, when the operator cancels the processing here, the whole processing ends. When the operator does not select cancellation of processing, the receiving apparatus controlling section 23 automatically makes part of finishing information invalid. (Step R54) This configuration that automatically makes part of finishing information invalid in Step R54 is equivalent to a configuration of this invention that changes finishing information of the unprocessible finishing content to set finishing information without any finishing content that the receiving apparatus cannot process when the finishing information contains items that the receiving apparatus cannot process. The finishing information that is changed or deleted is used as valid finishing information that contains no unprocessible finishing content at the finish-setting step (Step R55).

In the above judgment, it is possible to make processible finishing contents specific to receivers. In this case, the sender addresses acquired in analysis of the electronic-mail can be used to define finishing contents that the receiving apparatus can process. The processible finishing contents specific to receivers can be kept in the HDD 25. In other words, the HDD 25 also works as a sender-specific finishing content storing means. The HDD 25 can store finishing contents in forms of, for example, processible finishing content 1 for a specific address 1, processible finishing content 2 for a specific address 2, and general finishing content 1 for the other addresses.

The receiving apparatus controlling section 23 creates finishing control data for an image creating apparatus 30 (to be explained later) and a finisher 40 according to the above acquired finish-setting, and gives the control data to the image creating apparatus 30 and the finisher 40.

5. Image creation and finishing (Steps R6 and R7)

The image creating apparatus 30 receives image data from the receiving apparatus controlling section 23, causes the image creating section to perform image creation and processing (also including “N-in-1” and “Color” processing) from the image data, causes the image output section 32 to print out the formed image on proper paper sheets, and sends the printed sheets to the finisher 40. The finisher 40 performs finishing (such as punching) on the printed sheets according to the control data in the finish-setting. Thus the obtained printed sheets are finished as indicated by the sender's finishing information.

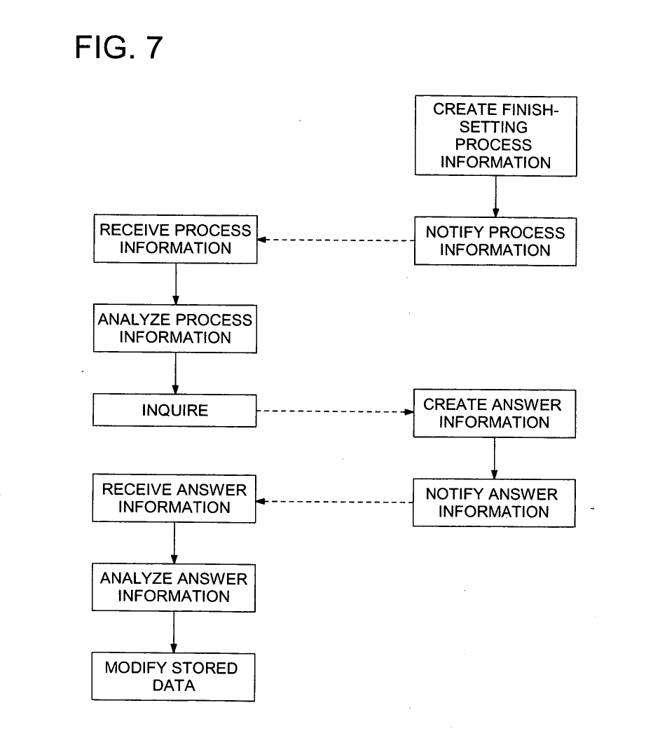

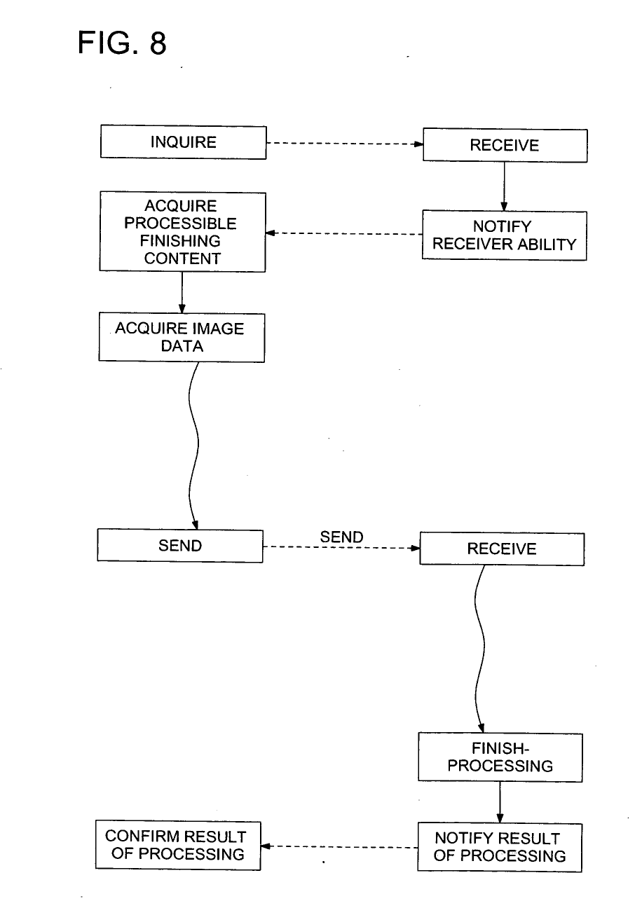

FIG. 7 and FIG. 8 show operating flowcharts of embodiments that enable bi-directional transmission between a sender and a receiver to assure processing.

FIG. 7 shows a procedure of notification after the print processing ends or stops. In this processing, the mail creating apparatus 1 controls the modem 7 to transfer electronic mails to and from a receiver via the network 11. In this case, the mail creating apparatus controlling section 5 works as an inquiry means. The mail receiving apparatus 23 in the receiver side controls the modem 24 to transfer electronic mails to and from the mail creating apparatus 1 via the network 11.

The sender creates processing information in the above processing and sends this processing information to the sender. After receiving this information, the sender analyzes it and inquires the receiver if necessary. For example, if the receiver has changed the definition pertaining to finish-processing, the sender inquires the receiver of the changed definition information. Further, the sender can inquire the receiver of the content of processing made by the receiver. In response to this inquiry, the receiver creates required answer information and sends it to the sender. The sender analyzes the answer information by this notification and modifies the sender's stored information if necessary. For example, if the definition of the finishing information has been changed by the receiver, the sender modifies the definition according to the receiver's definition. When the sender keeps receiver's processible finishing content in a storing medium, the sender compares the processible finishing content that the receiver answered by that stored in the medium. If they are not equal to each other, the sender can modify the stored finishing content according to the answered information. With this, the sender can use a correct and reliable printing instruction when creating and sending an electronic mail.

Referring to a flowchart of FIG. 8, the sender inquires the receiver of a finishing content that the receiver can process. In this processing, the mail creating apparatus controlling section 5 controls the modem 7 to send an inquiring electronic mail to the receiver through the network 11. In other words, the mail creating apparatus controlling section 5 works as an inquiring means.

When receiving an inquiring electronic mail, the receiver analyzes the mail, and informs the finishing ability of the receiver to the sender in response to the inquiry. In other words, the mail receiving apparatus 23 control the modem 24 to send a notifying mail to the sender via the network 11.

From this notifying mail, the sender gets the finishing content that the receiver can process. Data of this finishing content is kept in the HDD 6 and used as a processible finishing content for evaluation of the finishing information. Therefore, for evaluation of finishing information, only the finishing information that the receiver can process is acquired. This increases the reliability of finish-processing.

After sending the above inquiring mail and receiving the notification, the mail creating apparatus creates and sends electronic-mail data in the manner similar to that of the above embodiment. The receiver receives electronic-mail data and performs image creation and finish-processing according to the mail data also in the manner similar to that of the above embodiment.

The mail receiving apparatus that performed a series of above processes sends the status of the processes (up to the above finish-processing) as the process result data to the sender via the network 11. The process result data contains “Process Completed,” “Process Failed,” or “Process Stopped” to indicate a processing status.

When receiving this process result data, the sender lets the operator know the process result by displaying it on the display screen 4 or the like. When finding any uncompleted process on the screen, the operator can re-transmit the finishing information of the same content or correct and re-transmit the finishing information. With this, the processes can be performed without a fail.

Although the above-described embodiments are so constructed that receiver's processible finishing contents may be stored in the receiver and browsed for creation of electronic mails, the electronic-mail receiving apparatus and the electronic-mail communication system can also cancel transfer of electronic mails to and from an electronic-mail creating apparatus that does not have such stored information.

As already explained above, the electronic-mail receiving apparatus of this invention receives electronic-mail data containing image data and finishing information for image creation according to this image data, acquires image data and finishing information from the electronic-mail data, compares this finishing information by the finishing content that the receiving apparatus can output, and enables change of the finishing information according to the result of this comparison. As being designed to create images according to the image data and the changed finishing information, this electronic-mail receiving apparatus can perform image creation and finish-processing even when the finishing information set by the sender does not match the processing ability of the receiving apparatus.

Further, in accordance with this invention, it is possible to select advancing or stopping processing according to the result of comparison or to stop processing according to the result of comparison. Furthermore, it is possible to correct finishing information and set a finishing content without any items that the receiving apparatus cannot process if the finishing content contains any items that the receiving apparatus cannot process.

It is an effect of the configuration of this invention that the image creation and finish-processing can be done as the operator intends even when the finishing information set by the sender does not match the processing ability of the receiving apparatus.

In other words, this configuration enables the receiver to output according to the sender-specified finishing information when the receiver ability is available or allowed and enables the receiver to output according to the receiver's finish-setting when the receiver ability is not available or not allowed. Even when the sender system does not match the receiver system completely, the sender can instruct the receiver to print and output via a network.

Further, the electronic-mail creating apparatus of this invention is designed to acquire image data and a receiver address and create electronic-mail data with the image data, the receiver address, and finishing information that the receiver can output. This enables the sender to easily specify the receiver's finishing status and to make a print direction according to the receiver's ability.

Furthermore, this invention can suppress and prevent unsolicited mails and wrong-addressed mails by employing sender-specific processes.

Disclosed embodiment can be varied by a skilled person without departing from the spirit and scope of the invention.

1. An apparatus for receiving an electronic mail, said apparatus comprising:
a receiving section to receive electronic mail data including image data and finishing information for image forming operation based on said image data;
an acquiring section to acquire said image data and said finishing information from said electronic mail data;
a finishing information judging section to compare said finishing information with finishing contents processible for said apparatus;
a selecting section to select whether or not a changing operation of said finishing information is necessary, when said finishing information includes a finishing content unprocessible for said apparatus; and
a finish setting section to conduct a finish setting operation based on a result of a selecting operation conducted by said selecting section.

2. The apparatus of claim 1, further comprising:
an electronic mail analyzing section to acquire said image data and said finishing information included in said electronic mail by analyzing said electronic mail, when receiving said electronic mail.

3. The apparatus of claim 1, further comprising:
an apparatus-finishing content storing section to store said finishing content processible for said apparatus.

4. The apparatus of claim 1,
wherein, when said finishing information judging section determines that said finishing information do not include said finishing content unprocessible for said apparatus as a comparison result, said finishing information is applied for said finish setting operation as it is.

5. The apparatus of claim 2,
wherein said electronic mail analyzing section includes a finishing information rule storing section to store a rule with respect to a description of said finishing information, and analyzes said electronic mail data based on a content stored in said finishing information rule storing section to acquire said finishing information, when analyzing said electronic mail data.

6. The apparatus of claim 5,
wherein said finishing information rule storing section stores a tag description and said finishing information while correlating them with each other.

7. The apparatus of claim 1, further comprising:
a notifying section to notify a sender of said electronic mail, when said finishing information of said electronic mail includes said finishing content unprocessible for said apparatus.

8. The apparatus of claim 7,
wherein said notifying section notifies said sender of a fact that said finishing information includes said finishing content unprocessible for said apparatus and a processing content corresponding to said fact.

9. The apparatus of claim 1, further comprising:
a notifying section to notify a sender of said finishing content processible for said apparatus.

10. The apparatus of claim 1,
wherein finishing contents are different from each other depending on senders.

11. The apparatus of claim 1, further comprising:
an individual-sender finishing content storing section to store identifying information for an individual-sender and a finishing content, which is allowed for said individual-sender, while correlating them with each other.

12. The apparatus of claim 1, further comprising:
a sender rejecting section to stop an image-forming operation based on said image data included in said electronic mail, when an address of a sender coincides with a rejecting address established in advance.

13. The apparatus of claim 1, further comprising:
a sender restricting section to allow an image-forming operation based on said image data included in said electronic mail, only when an address of a sender coincides with an allowed address established in advance.

14. The apparatus of claim 1, further comprising:
an image-forming section to conduct an image-forming operation based on said image data.

15. The apparatus of claim 1, further comprising:
a finishing section to apply a finish processing to a formed image;
wherein said finishing section performs said finish processing based on said finish setting.

16. An apparatus for receiving an electronic mail, said apparatus comprising:
a receiving section to receive electronic mail data including image data and finishing information for image forming operation based on said image data;
an acquiring section to acquire said image data and said finishing information from said electronic mail data;
a finishing information judging section to compare said finishing information with a finishing content processible for said apparatus; and
a process selecting section to select whether a processing operation should be proceeded or stopped, when said finishing information includes a finishing content unprocessible for said apparatus as a comparison result conducted in said finishing information judging section.

17. An apparatus for receiving an electronic mail, said apparatus comprising:
a receiving section to receive electronic mail data including image data and finishing information for image forming operation based on said image data;
an acquiring section to acquire said image data and said finishing information from said electronic mail data;
a finishing information judging section to compare said finishing information with a finishing content processible for said apparatus; and
a process stopping section to stop a finish processing, when said finishing information includes a finishing content unprocessible for said apparatus as a comparison result conducted in said finishing information judging section.

18. An apparatus for receiving an electronic mail, said apparatus comprising:
a receiving section to receive electronic mail data including image data and finishing information for image forming operation based on said image data;
an acquiring section to acquire said image data and said finishing information from said electronic mail data;
a finishing information judging section to compare said finishing information with a finishing content processible for said apparatus; and
a finish setting section to conduct a finish setting operation, which does not include a finishing content unprocessible for said apparatus, after changing said finishing information in respect to said finishing content unprocessible for said apparatus, when said finishing information includes said finishing content unprocessible for said apparatus as a comparison result conducted in said finishing information judging section.

19. A system for communicating an electronic mail, said system comprising:
an electronic mail creating apparatus to create electronic mail data including image data and finishing information; and
an electronic mail receiving apparatus that includes a receiving section to receive said electronic mail data including said image data and said finishing information transmitted by said electronic mail creating apparatus, and a finishing information judging section to compare said finishing information with a finishing content processible for said apparatus, to conduct an image-forming operation based on said finishing information;
wherein said electronic mail receiving apparatus notify said electronic mail creating apparatus, when said finishing information includes said finishing content unprocessible for said apparatus as a comparison result conducted in said finishing information judging section.

20. A system for communicating an electronic mail, said system comprising:
an electronic mail creating apparatus to create electronic mail data including image data and finishing information; and
an electronic mail receiving apparatus that includes a receiving section to receive said electronic mail data including said image data and said finishing information transmitted by said electronic mail creating apparatus, to conduct an image-forming operation based on said finishing information;
wherein said electronic mail receiving apparatus notify said electronic mail creating apparatus of finishing information processible for said electronic mail receiving apparatus, corresponding to an inquiry from said electronic mail creating apparatus to said electronic mail receiving apparatus.

21. A system for communicating an electronic mail, said system comprising:
an electronic mail creating apparatus that acquires image data and an address of a receiver when creating said electronic mail, to create electronic mail data including said image data, said address of said receiver and finishing information for forming an image based on said image data; and
an electronic mail receiving apparatus described in claim 1.

22. An apparatus for communicating an electronic mail, said apparatus comprising:
an acquiring section to acquire said image data and an address of a receiver of said electronic mail; and
an electronic mail creating section to create electronic mail data including finishing information described by said image data, said address of said receiver of said electronic mail and a tag.

23. The apparatus of claim 22,
wherein said finishing information includes at least one of a designation of color or black and white, a designation of enlargement or reduction and a punching operation.

24. The apparatus of claim 22,
wherein said finishing information are described in a main description of said electronic mail.

25. The apparatus of claim 22,
wherein said finishing information are described in a header of said electronic mail.

26. The apparatus of claim 23, further comprising:
an image data acquiring section to acquire said image data;
a receiver acquiring section to acquire said address of said receiver of said electronic mail;
a finishing information acquiring section to acquire said finishing information for forming an image; and
an electronic mail data generating section to generate said electronic mail data including said address of said receiver, said finishing information and said image data.

27. The apparatus of claim 26,
wherein said electronic mail data generating section is so constituted that it generates said electronic mail data, which has said address at a header, said finishing information provided as a main description and said image data added to said main description.

28. The apparatus of claim 26,
wherein said image data acquiring section is provided with an image data storing section in which said image data are stored.

29. The apparatus of claim 26,
wherein said image data acquiring section is provided with a scanner for reading an image to generate said image data.

30. The apparatus of claim 26,
wherein said receiver acquiring section is provided with a receiver inputting section for setting a receiver by means of an inputting operation of a sending operator.

31. The apparatus of claim 26,
wherein said receiver acquiring section is provided with a receiver storing section for memorizing a receiver.

32. The apparatus of claim 26,
wherein said finishing information acquiring section is provided with a finishing information inputting section for setting said finishing information by means of an inputting operation of a sending operator.

33. The apparatus of claim 26,
wherein said finishing information acquiring section can acquire only such finishing information that are described by a rule established in advance.

34. The apparatus of claim 33,
wherein said rule relates to a description by a tag.

35. The apparatus of claim 26,
wherein said finishing information acquiring section is provided with a finishing content storing section for storing finishing content data being acquirable.

36. The apparatus of claim 26, further comprising:
a model finishing content storing section to store a finishing content being processible as data of every model for a finishing section.

37. The apparatus of claim 26, further comprising:
a receiver model data storing section that stores model data of a finishing section provided in said receiver while correlating it to receiver identifying information.

38. The apparatus of claim 26,
wherein said apparatus is so constituted that said apparatus acquires receiver identifying information to identify a receiver, and can select a finishing content being usable for a finishing section provided in said receiver.

39. The apparatus of claim 26,
wherein said apparatus is so constituted that said apparatus acquires receiver identifying information, and acquires receiver model data from said receiver model data storing section, based on said receiver identifying information, and acquires a finishing content being selectable from model finishing content storing section, based on said model data.

40. The apparatus of claim 26, further comprising:
an inquiring section to inquire a finishing content being processible for a receiver from said receiver.

41. The apparatus of claim 40,
wherein, when said inquiring section obtains said finishing content being processible for said receiver, said finishing information acquiring section can acquire only such finishing information that are limited within said finishing content.

42. The apparatus of claim 26, further comprising:
a communicating section to communicate said electronic mail by coupling to a network.
